(19) United States
(12) Patent Application Publication
(10) Pub. No.: US 2011/0200190 A1
(43) Pub. Date: Aug. 18, 2011

(54) CRYPTOGRAPHY PROCESSING DEVICE AND CRYPTOGRAPHY PROCESSING METHOD

(75) Inventor: Tooru HISAKADO, Kanagawa (JP)

(73) Assignee: RENESAS ELECTRONICS CORPORATION, Kanagawa (JP)

(21) Appl. No.: 13/027,945

(22) Filed: Feb. 15, 2011

(30) Foreign Application Priority Data
Feb. 16, 2010 (JP) 2010-031528

(51) Int. Cl. G06F 7/58; H04L 9/06

(52) U.S. Cl. 380/46; 708/250

(57) ABSTRACT

A cryptography processing device has: a round processing unit configured to obtain a processing-object data and generate an intermediate data by applying round processing to the processing-object data; a random number generation unit configured to generate a random number data; a memory circuit in which the intermediate data or the random number data is stored; and a selection control unit configured to select which one of the intermediate data and the random number data is to be stored in the memory circuit. The selection control unit selects the data to be stored in the memory circuit such that the random number data is stored after the intermediate data is stored.

### INCORPORATION BY REFERENCE

This application is based upon and claims the benefit of priority from Japanese patent application No. 2010-031528, filed on Feb. 16, 2010, the disclosure of which is incorporated herein in its entirety by reference.

### BACKGROUND OF THE INVENTION

1. Field of the Invention

The present invention relates to a cryptography processing device and a cryptography processing method.

2. Description of Related Art

With increasing need for security, need for a cryptography processing device that can encrypt large volumes of data at a high speed also is increasing. It is effective for handling the large volumes of data to use a common key cryptosystem. The common key cryptosystem is exemplified by TDES (Triple Data Encryption Standard), AES (Advanced Encryption Standard) and the like. Moreover, it is effective for a high-speed operation to configure the cryptography processing device based on hardware.

Regarding the cryptography processing device provided with the common key cryptosystem, threats of a differential power analysis (DPA) that is one kind of side channel attack are increasing. For example, refer to Non-Patent Literature 1: Paul Kocher, Joshua Jaffe, Benjamin Jun, “Introduction to Differential Power Analysis and Related Attacks”, 1998.

According to the side channel attack, a secret key (private key) is estimated by the use of side channel information (for example, power consumption, electromagnetic wave, processing time and so forth) that is generated at a time of encryption processing. For example, the power consumption in the cryptography processing device may vary according to an intermediate data that is generated in the middle of the encryption processing. According to the DPA, the power consumption is measured, the intermediate data is estimated based on the measured power consumption, and the secret key is estimated based on the intermediate data. The same applies to cases where the electromagnetic wave and the like are used as the side channel information. For example, refer to Non-Patent Literature 2: K. Gandolfi, C. Mourtel, and F. Olivier, “Electromagnetic Analysis: Concrete Results,” CHES 2001, LNCS 2162, pp. 251-262, 2001.

Patent Literature 1 (Japanese Patent Publication 2000-305453) describes an encryption device which is a technique related to countermeasures against DPA. In the encryption device, an intermediate data control means performs, in response to an intermediate data change request, a “random number dependent intermediate data change operation” that inputs a random number and changes an intermediate data depending on the random number. In the encryption device, a data necessary at an intermediate stage in the encryption processing is changed depending on the random number. Even if an attacker tries to obtain information of the intermediate data by measuring the power consumption at a time when an operation is performed with respect to the intermediate data, a value of the intermediate data is affected by the random number and thus the attacker can hardly determine whether the power consumption is varied due to the influence of the random number or the power consumption is varied depending on the data necessary for the encryption processing. Therefore, DPA resistivity can be enhanced.

However, according to the encryption device described in the Patent Literature 1, the encryption processing is applied to the data affected by the random number, and thus the processing becomes complicated and a circuit size is increased. Moreover, throughput is reduced.

Patent Literature 2 (Japanese Patent Publication 2005-31471) discloses a cryptography processing device which is intended to increase cryptanalysis resistance without complicating a processing algorithm. FIG. 1 is a block diagram showing the cryptography processing device described in the Patent Literature 2. As shown in FIG. 1, the cryptography processing device has a F-function unit 300, a first data storage unit 310 and a second data storage unit 320. According to the cryptography processing device, an intermediate data output value obtained by the F-function unit 300 is transferred through an XOR unit 306 to be stored as it is in an R register 312 and an L register 311 included in the first data storage unit 310. Moreover, an inverted data of the output data from the XOR unit 306 is stored in an R′ register 322 and an L′ register 332 included in the second data storage unit 320. It is thus possible to keep a sum of Hamming weights in the register storing processing constant. The Hamming weight affects the power consumption. Since the sum of Hamming weights is kept constant, it becomes hard to estimate the Hamming weight based on the power consumption. Thus, it is possible to increase resistance to the analysis based on change in the power consumption.

### SUMMARY

In a typical cryptography processing device, a round processing is applied to an input data for plural number of times and accordingly an output data is generated. An intermediate data generated by each round processing is stored in a register. The intermediate data stored in the register is changed each time the round processing is executed. An amount of power consumption change depends on the Hamming weight and Hamming distance when the data stored in the register is changed. Therefore, there is a possibility that the change in the power consumption is measured, the Hamming weight or the Hamming distance is estimated from the measuring result and then a secret key is specified based on the estimation result. It should be noted that, in a case where the cryptography processing device is achieved by software, the Hamming weight is more likely to affect the power consumption. On the other hand, in a case where the cryptography processing device is achieved by hardware, the Hamming distance (the number of changed bits) is more likely to affect the power consumption.

The cryptography processing device described in the above-mentioned Patent Literature 2 may have the DPA resistivity in a case where the Hamming weight mainly contributes to the power consumption. However, the Patent Literature 2 describes nothing about the Hamming distance (the number of changed bits). It can be said for the cryptography processing device described in the Patent Literature 2 that the DPA resistivity is rather deteriorated from a viewpoint of the number of changed bits. This point will be described below.

FIG. 2 shows an example of a relationship between output data from the XOR unit 306, Hamming weights and the numbers of changed bits according to the encryption processing circuit shown in FIG. 1. Specifically, FIG. 2 shows a relationship between the output data from the XOR unit 306, data stored in the R register 312, data stored in the R′ register, the Hamming weights and the numbers of changed bits. Regarding the Hamming weight, the R register, the R′ register and a sum of the R register and the R′ register are shown. Similarly, regarding the number of changed bits, the R register, the R′ register and a sum of the R register and the R′ register are shown. It should be noted that, although each data is a 32-bits data, four bits of the 32-bits data will be considered for simplicity in the following description.

As shown in FIG. 2, the output data from the XOR unit 306 (i.e. the data to be stored in the R register 312) at a time t=0 is “4'b0000”. Then, the output data changes in a period from the time t=0 to a time t4 such that the Hamming weight is increased by one each time. Moreover, the output data changes in a period from a time t=5 to a time t=9 such that the number of changed bits is increased from 0 by one each time.

First, the Hamming weight will be described. In the period from the time t=0 to the time t=4, the Hamming weight in the R register is increased from 0 to 4 by one each time. Meanwhile, the Hamming weight in the R′ register is decreased from 4 to 0 by one each time. As a result, a sum of the Hamming weight in the R register and the Hamming weight in the R′ register is constantly 4 at any time. The same applies to a period after the time t=5, and a sum of the Hamming weights is constantly 4 at any time.

Next, the number of changed bits will be described. In the period from the time t=5 to the time t=9, the number of changed bits in the R register is increased from 0 to 4 by one each time. Similarly, the number of changed bits in the R′ register is increased from 0 to 4 by one each time. As a result, a sum of the number of changed bits in the R register and the number of changed bits in the R′ register is increased from 0 to 8 by two each time. Therefore, in a case where change in the number of changed bits causes change in the power consumption, there is a possibility that the power consumption is estimated from the number of changed bits. In other words, the DPA attack may be allowed. Moreover, the sum of the numbers of changed bits becomes twice as compared with a case where the L′ register and the R′ register are not added. In this sense, it can be said that the DPA resistivity is rather deteriorated from a viewpoint of the number of changed bits.

In an aspect of the present invention, a cryptography processing device is provided. The cryptography processing device has: a round processing unit configured to obtain a processing-object data and generate an intermediate data by applying round processing to the processing-object data; a random number generation unit configured to generate a random number data; a memory circuit in which the intermediate data or the random number data is stored; and a selection control unit configured to select which one of the intermediate data and the random number data is to be stored in the memory circuit. The selection control unit selects the data to be stored in the memory circuit such that the random number data is stored after the intermediate data is stored.

In another aspect of the present invention, a cryptography processing method is provided. The cryptography processing method includes: obtaining a processing-object data and generating an intermediate data by applying round processing to the processing-object data; generating a random number data; storing the intermediate data or the random number data in a memory circuit; and selecting which one of the intermediate data and the random number data is to be stored in the memory circuit. The selecting includes: selecting the data to be stored in the memory circuit such that the random number data is stored after the intermediate data is stored.

According to the cryptography processing device and the cryptography processing method of the present invention, resistance to the DPA attack can be increased.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram showing a cryptography processing device described in the Patent Literature 2;

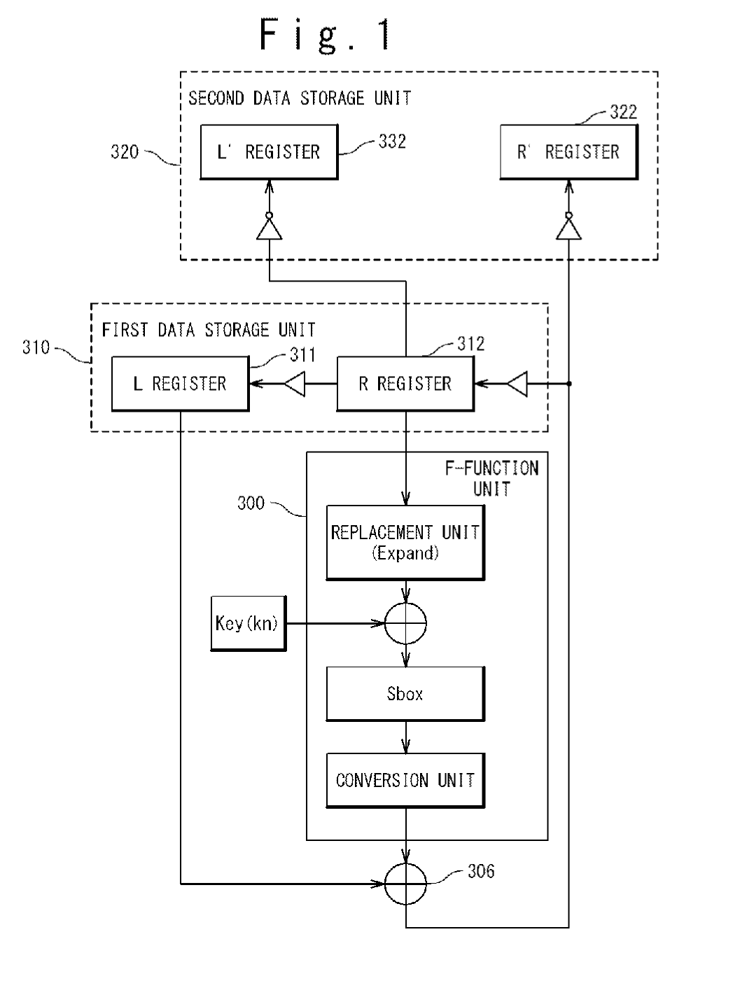

FIG. 2 shows an example of a relationship between output data, Hamming weights and the numbers of changed bits;

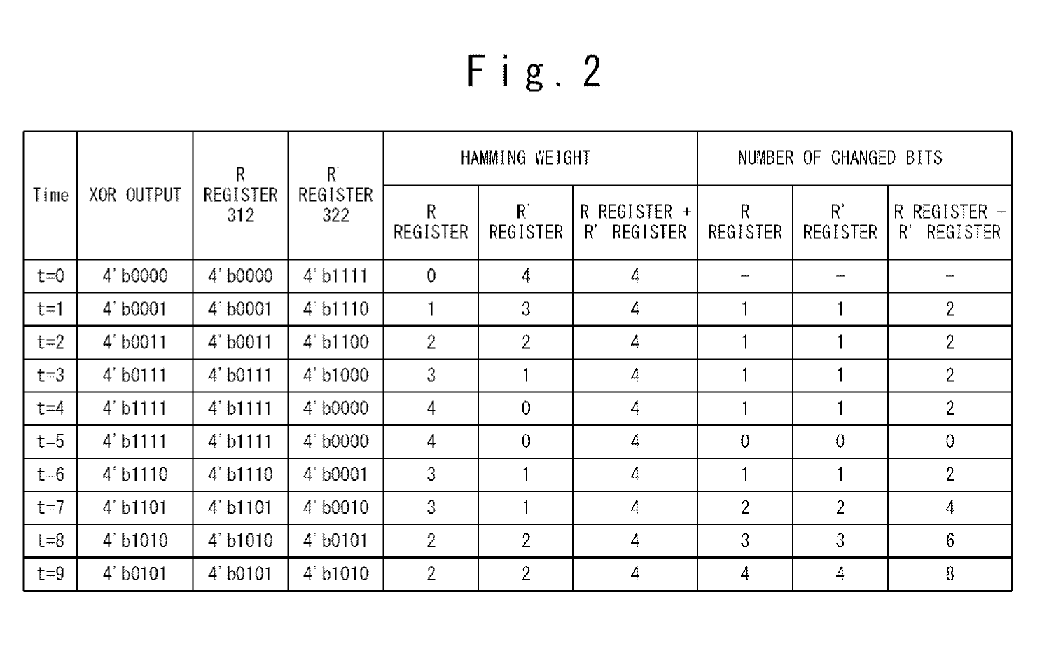

FIG. 3 is a block diagram showing a cryptography processing device according to an embodiment of the present invention;

FIG. 4 is a timing chart showing an operation method of the cryptography processing device according to the embodiment of the present invention; and

FIG. 5 is a block diagram showing a modification example of the cryptography processing device according to the embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

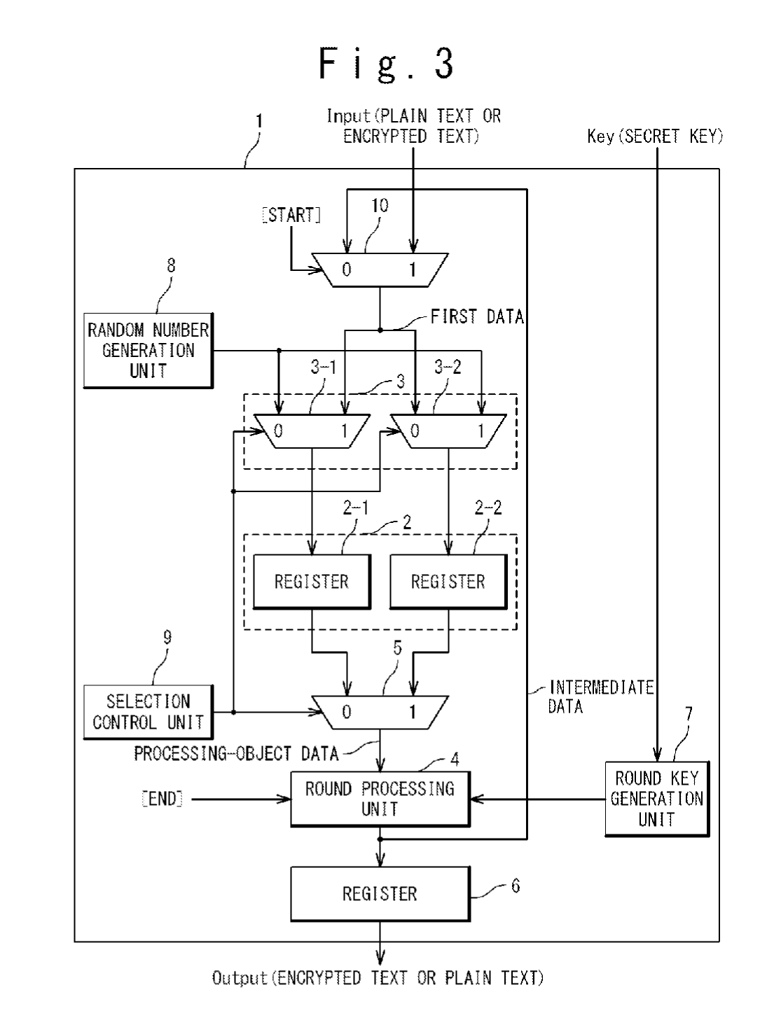

FIG. 3 is a block diagram showing a cryptography processing device 1 according to the present embodiment. The cryptography processing device 1 is configured to apply a cryptography processing to an input data (Input; plain text) based on the input data and a secret key data to generate an output data (Output; encrypted text). The cryptography processing device 1 is achieved by hardware.

As shown in FIG. 3, the cryptography processing device 1 has a selector 10, a register unit 2 (memory circuit unit), register input selectors (3-1, 3-2), a register output selector 5, a round processing unit 4, a register 6, a round key generation unit 7, a random number generation unit 8 and a selection control unit 9. The register unit 2 has a plurality of registers (2-1, 2-2) as a plurality of memory circuits.

The selector 10 is configured to select and output any one of the input data (plain text) and an output data (intermediate data) output from the round processing unit 4. The selector 10 receives a start signal Start and selects any one of the input data and the intermediate data depending on the start signal Start. It should be noted that the start signal Start is generated by a start signal generation circuit (not shown). The selected data (hereinafter referred to as a first data) is supplied to a register input selector 3-1 and a register input selector 3-2.

The random number generation unit 8 is a circuit that generates a random number data. The generated random number data is supplied to the register input selector 3-1 and the register input selector 3-2.

The selection control unit 9 is a circuit that controls respective operations of the register input selector 3-1, the register input selector 3-2 and the register output selector 5. The selection control unit 9 generates a selection control signal and supplies the selection control signal to the register input selector 3-1, the register input selector 3-2 and the register output selector 5.

The register input selector 3-1 selects any one of the first data and the random number data depending on the selection control signal. More specifically, the register input selector 3-1 is configured to select the first data in a case where the selection control signal is at the High level “1” and to select the random number data in a case where the selection control signal is at the Low level “0”. The register input selector 3-1 is connected to the register 2-1 and stores the selected data in the register 2-1 at a timing when a clock signal CLK rises to the High level. It should be noted that the clock signal CLK is generated by a clock signal generation circuit (not shown).

Similarly, the register input selector 3-2 selects any one of the first data and the random number data depending on the selection control signal. The register input selector 3-2 is connected to the register 2-2 and stores the selected data in the register 2-2 at a timing when the clock signal CLK rises to the High level. It should be noted that the register input selector 3-1 and the register input selector 3-2 are set such that one selector selects the first data while the other selector selects the random number data. That is, the register input selector 3-2 is configured to select the first data in the case where the selection control signal is at the Low level “0” and to select the random number data in the case where the selection control signal is at the High level “1”.

Each register 2 (2-1, 2-2) is configured to store the first data or the random number data. Also, each register 2 outputs the stored data to the register output selector 5.

The register output selector 5 selects the first data from a plurality of data respectively output from the plurality of registers 2, in accordance with the selection control signal. Then, the register output selector 5 outputs (transfers) the selected first data as a processing-object data to the round processing unit 4. More specifically, the register output selector 5 is configured to select the data stored in the register 2-1 in the case where the selection control signal is at the Low level “0” and to select the data stored in the register 2-2 in the case where the selection control signal is at the High level “1”.

The round key generation unit 7 receives (obtains) a secret key data that is prepared beforehand and generates a round key data based on the secret key data. The round key data is supplied to the round processing unit 4.

The round processing unit 4 receives the processing-object data from the register output selector 5 and applies the round processing to the processing-object data by the use of the round key data. As a result of the round processing, the intermediate data is generated. The intermediate data is supplied to the selector 10 as mentioned above. It should be noted that when the number of execution times of the round processing reaches a predetermined number of times, the data obtained as a result of the round processing is stored as the output data (Output) in the register 6. More specifically, when the number of execution times of the round processing reaches the predetermined number of times, an end signal generation circuit (not shown) supplies a High level signal as an end signal END to the round processing unit 4. When receiving the end signal END, the round processing unit 4 stored the output data in the register 6.

The register 6 outputs the output data as a result of the processing by the cryptography processing device 1.

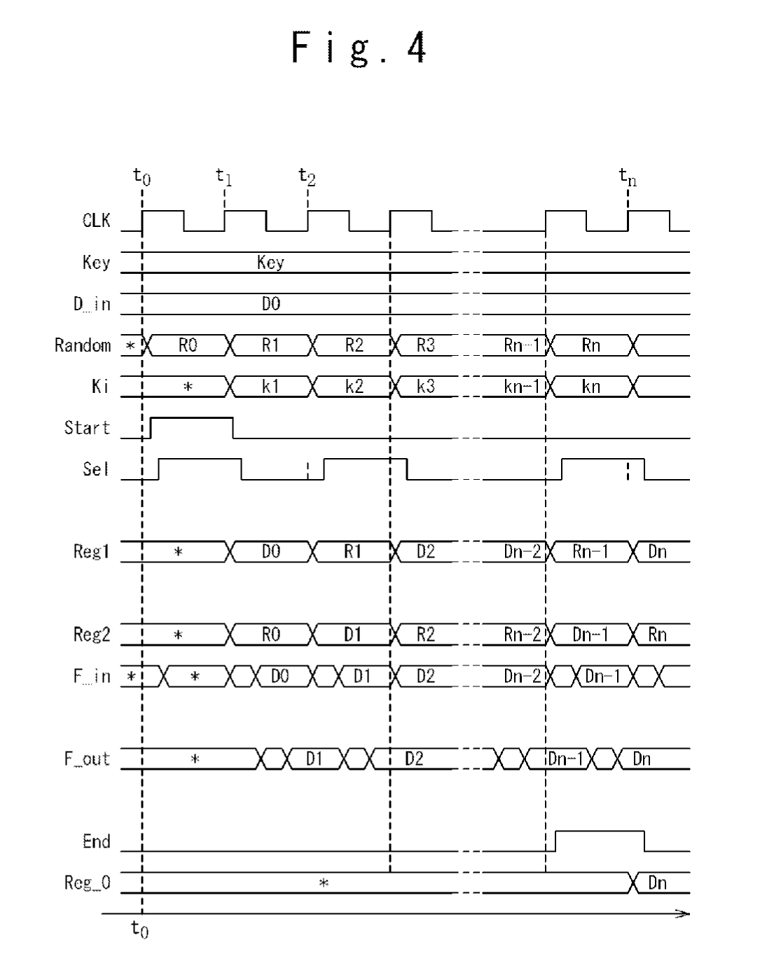

Next, an operation method of the cryptography processing device 1 according to the present embodiment will be described. FIG. 4 is a timing chart showing the operation method of the cryptography processing device 1 according to the present embodiment. Shown in FIG. 4 are the clock signal [CLK], the secret key data [Key], the input data [D_in], the random number data [Random], the round key data [Ki], the start signal [Start], the selection control signal [Sel], the data [Reg_1] stored in the register 2-1, the data [Reg_2] stored in the register 2-2, the data (processing-object data) [F_in] supplied to the round processing unit 4, the data [F_out] output from the round processing unit 4, the end signal [End] and the output data [Reg_o].

In FIG. 4, timings at which the clock signal CLK rises from the Low level to the High level include a time t0, a time t1, a time t2, . . . a time tn.

First, an operation during a period from the time t0 to the time t1 will be described.

At the time t0, the cryptography processing device 1 starts operating, and a High level signal as the start signal Start is supplied. Also, a secret key data Key as the secret key data [Key] is supplied. Also, an input data D0 as the input data [D_in] is supplied.

Since the High level signal as the start signal Start is supplied, the selector 10 selects the input data D0 as the first data. Moreover, the selection control unit 9 supplies a High level signal as the selection control signal Sel. As a result, the register input selector 3-1 selects the first data (input data D0) while the register input selector 3-2 selects a random number data R0. In other words, the selection control unit 9 selects the register 2-1 as a “selected register” in which the first data is to be stored. The register 2-2 that is not selected as the selected register at this time is a non-selected register.

Next, an operation during a period from the time t1 to the time t2 will be described.

At the time t1 when the clock signal CLK rises to the High level, the register input selector 3-1 stores the selected first data (input data D0) in the register 2-1 (selected register). As a result, the data Reg_1 stored in the register 2-1 becomes the input data D0. Also, the register input selector 3-2 stores the selected random number data R0 in the register 2-2 (non-selected register). As a result, the data Reg_2 stored in the register 2-2 becomes the random number data R0. After the data are stored in the respective registers 2, the start signal Start is reset to the Low level.

Also, the round key generation unit 7 generates a round key data K1 based on the secret key data Key.

After that, the selection control unit 9 inverts the level of the selection control signal Sel and supplies a Low level signal as the selection control signal Sel. As a result, the register output selector 5 selects the data (first data=input data D0) stored in the register 2-1 and outputs it as the processing-object data to the round processing unit 4. That is, the processing-object data [F_in] becomes the input data D0. It should be noted here that the level of the selection control signal Sel being inverted by the selection control unit 9 means that the selected register (the register in which the first data is to be stored) is changed from the register 2-1 to the register 2-2. Thus, the post-change selected register becomes the register 2-2, while the register 2-1 becomes the post-change non-selected register.

The round processing unit 4 receives the processing-object data (input data D0) and applies the round processing to the processing-object data to generate an intermediate data D1. That is, the data [F_out] output from the round processing unit 4 becomes the intermediate data D1.

The start signal Start has been reset to the Low level before the intermediate data D1 is generated. Therefore, the selector 10 selects the intermediate data D1 as the first data. Since the selection control signal Sel is at the Low level at this time, the register input selector 3-1 selects a random number data R1 while the register input selector 3-2 selects the intermediate data D1.

Next, an operation after the time t2 will be described. At the time t2 when the clock signal CLK rises to the High level, the register input selector 3-1 stores the random number data R1 in the register 2-1 (post-change non-selected register). That is, the data [Reg_1] stored in the register 2-1 becomes the random number data R1. Also, the register input selector 3-2 stores the intermediate data D1 in the register 2-2 (post-change selected register). That is, the data [Reg_2] stored in the register 2-2 becomes the intermediate data D1.

The above-described processing is repeated for a predetermined number of times (n times) with the selection control signal Sel being inverted repeatedly. When the number of execution times of the round processing by the round processing unit 4 reaches the predetermined number of times, a High level signal as the end signal End is supplied. Then, at the time to when the clock signal CLK rises to the High level, the output data Dn output from the round processing unit 4 is stored in the register 6. The register 6 outputs the output data Dn as the encrypted text.

In this manner, the selection control unit 9 controls the operations of the register input selectors (3-1, 3-2) so as to store the intermediate data in the selected register and controls the operation of the register output selector 5 so as to transfer the processing-object data from the selected register to the round processing unit 4. That is, the selection control unit 9 selects which ones of the intermediate data and the random number data are to be stored in the respective registers 2-1 and 2-2. Moreover, the selection control unit 9 changes the selected register after the intermediate data is transferred from the selected register to the subsequent stage, and after that the random number data is stored in the post-change non-selected register group. That is, the selection control unit 9 selects the data to be stored in the respective registers 2-1 and 2-2 such that the random number data is stored immediately after the intermediate data is stored.

According to the above-described operation, not only the intermediate data but also the random number data is stored in each register (2-1, 2-2). Therefore, the number of changed bits in each register (2-1, 2-2) takes a random value. Thus, an attacker cannot estimate an actual number of changed bits even if the attacker can obtain side channel information such as the power consumption, unless a random number indicated by the random number data is known. That is to say, the cryptography processing device 1 according to the present embodiment can enhance the DPA resistivity, although it is achieved by the hardware.

Moreover, according to the present embodiment, either the input data or the intermediate data is supplied as the processing-object data to the round processing unit 4. Therefore, the round processing unit 4 can utilize a commonly-used cryptographic algorithm to execute the round processing. Since the processing-object data itself is not affected by a random number, it is possible to prevent the cryptographic algorithm from being complicated and to suppress increase in the circuit size.

The case where the input data is the plain text and the output data is the encrypted text is described in the above embodiment. The same applies to a case where the input data is an encrypted text and the output data is a plain text.

In the above-described embodiment, as shown in FIG. 4, the random number generation unit 8 changes the value of the random number data at the timing when the clock signal CLK rises. However, the random number data may be a fixed-value data.

In the above-described embodiment, the register unit 2 has the two registers. This is just an example, and the number of registers included in the register unit 2 is not limited to two. The number of registers included in the register unit 2 can be equal to or more than 3, as long as each register is configured such that the random number data is stored after the intermediate data is stored.

In the above-described embodiment, the intermediate data generated by the round processing unit 4 is stored again in the register unit 2 through the selector 10 and the register input selector 3. That is to say, in the above-described embodiment, the cryptography processing device 1 has a loop configuration in which the round processing is repeated for plural times by using the same round processing unit 4. However, the configuration of the cryptography processing device 1 is not limited to that. The cryptography processing device 1 may have a pipeline configuration in which a plurality of circuit sections are connected in series. This modification example will be described below.

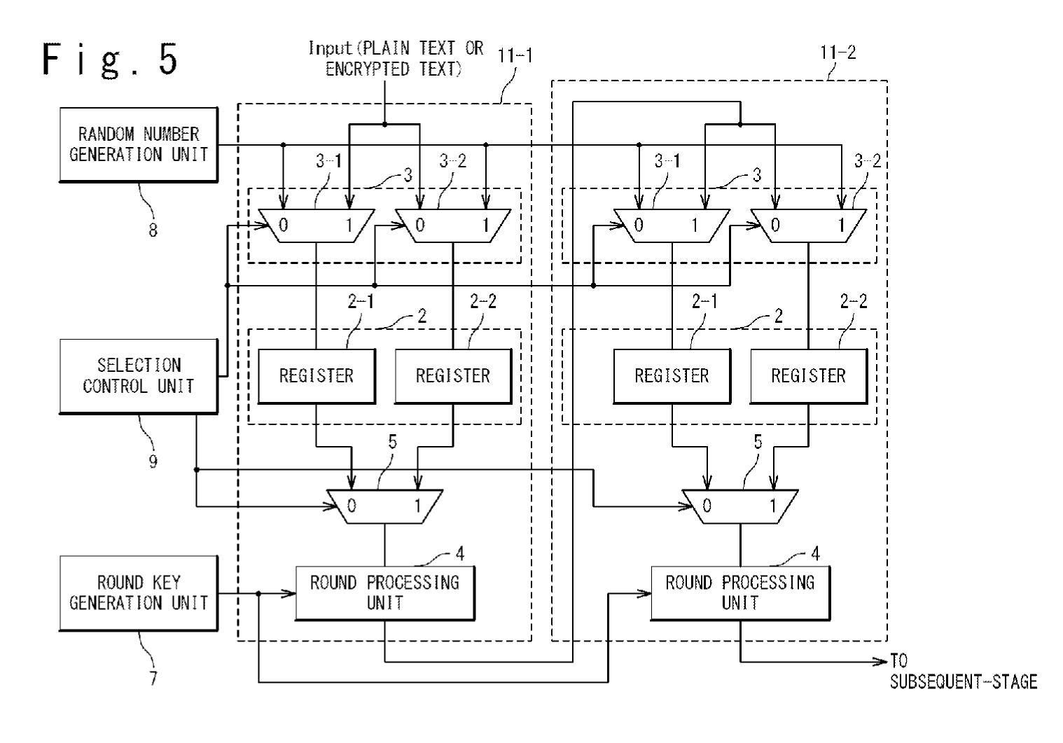

FIG. 5 is a block diagram showing a modification example of the cryptography processing device 1 according to the present embodiment. The cryptography processing device 1 in the modification example is provided with a plurality of circuit sections 11 (first circuit section 11-1, second circuit section 11-2, . . . ). Note that the selector 10 is omitted. Each of the circuit sections 11 has the register input selector 3, the register unit 2, the register output selector 5 and the round processing unit 4 as in the case of the cryptography processing device 1 shown in the foregoing FIG. 3, and its operation is similar to that of the cryptography processing device 1 shown in FIG. 3. With respect to the first-stage circuit section (first circuit section 11-1), the input data (Input) is supplied to the register input selector 3. The intermediate data generated by the round processing unit 4 in a former-stage circuit section 11 is supplied to the register input selector 3 in the subsequent-stage circuit section 11. Even in this case of the pipeline configuration, the random number data is stored immediately after the intermediate data in each register (2-1, 2-2) included in the register unit 2. Therefore, the number of changed bits in each register (2-1, 2-2) is prevented from being estimated by an attacker, and thus the DPA resistivity can be enhanced.

It is apparent that the present invention is not limited to the above embodiments and may be modified and changed without departing from the scope and spirit of the invention.

What is claimed is:

1. A cryptography processing device comprising:
a round processing unit configured to obtain a processing-object data and generate an intermediate data by applying round processing to said processing-object data;
a random number generation unit configured to generate a random number data;
a memory circuit in which said intermediate data or said random number data is stored; and
a selection control unit configured to select which one of said intermediate data and said random number data is to be stored in said memory circuit,
wherein said selection control unit selects the data to be stored in said memory circuit such that said random number data is stored after said intermediate data is stored.

2. The cryptography processing device according to claim 1,
wherein a number of said memory circuit is plural,
wherein said selection control unit selects a selected memory circuit from said plurality of memory circuits and stores said intermediate data in said selected memory circuit,
wherein said selection control unit changes said selected memory circuit after said intermediate data is transferred from said selected memory circuit to a subsequent stage, and stores said random number data in a post-change non-selected memory circuit group that is not selected as said selected memory circuit.

3. The cryptography processing device according to claim 2,
wherein said intermediate data stored in said selected memory circuit is transferred as said processing-object data to said round processing unit.

4. The cryptography processing device according to claim 2, further comprising:
a plurality of memory circuit input selectors respectively connected to said plurality of memory circuits; and
a memory circuit output selector provided between said plurality of memory circuits and said round processing unit,
wherein each of said plurality of memory circuit input selectors selects any one of said intermediate data and said random number data and outputs the selected one to the corresponding one of said plurality of memory circuits,
wherein said memory circuit output selector selects a data stored in any one of said plurality of memory circuits and outputs the selected data as said processing-object data to said round processing unit,
wherein said selection control unit controls operations of said plurality of memory circuit input selectors so as to store said intermediate data in said selected memory circuit, and controls an operation of said memory circuit output selector so as to transfer said processing-object data from said selected memory circuit to said round processing unit.

5. The cryptography processing device according to claim 1, further comprising: a round key generation unit configured to obtain a secret key data that is prepared beforehand and generate a round key data based on said secret key data,
wherein said round processing unit applies the round processing to said processing-object data by using said round key data.

6. The cryptography processing device according to claim 1,
wherein said memory circuit is a register.

7. A cryptography processing method comprising:
obtaining a processing-object data and generating an intermediate data by applying round processing to said processing-object data;
generating a random number data;
storing said intermediate data or said random number data in a memory circuit; and
selecting which one of said intermediate data and said random number data is to be stored in said memory circuit,
wherein said selecting comprises selecting the data to be stored in said memory circuit such that said random number data is stored after said intermediate data is stored.
